(19) United States
(12) Patent Application Publication
(10) Pub. No.: US 2024/0066849 A1
(43) Pub. Date: Feb. 29, 2024

(54) EPOXY RESIN COMPOSITION AND TRANSPARENT COMPOSITE MATERIAL COMPRISING SAME, AND LAMINATED BOARD

(71) Applicant: GUANGDONG HINNO-TECH CO., LTD., Guangzhou (CN)

(72) Inventors: Xiaolong QI, Guangzhou (CN); Jiabin YU, Guangzhou (CN); Yangjie ZHU, Guangzhou (CN); Jianxiong CHEN, Guangzhou (CN)

(21) Appl. No.: 18/270,154

(22) PCT Filed: Jul. 30, 2021
(86) PCT No.: PCT/CN2021/109669

§ 371 Date: Jun. 28, 2023

(30) Foreign Application Priority Data
Dec. 28, 2020 (CN) 202011577184.X

(51) Int. Cl. B32B 27/38; B32B 3/16; B32B 5/28; B32B 7/023; B32B 27/08; B32B 27/18; B32B 37/10

(52) U.S. Cl. CPC B32B 27/38; B32B 3/16; B32B 5/28; B32B 7/023; B32B 27/08; B32B 27/18; B32B 37/1018; B32B 2260/04; B32B 2262/101; B32B 2305/076; B32B 2307/40; B32B 2309/025; B32B 2363/00

(57) ABSTRACT

An epoxy resin composition, a transparent composite material including the same, and a laminated board. The epoxy resin composition includes an epoxy resin A and an epoxy resin B. The refractive index of the epoxy resin A is 1.54-1.8 and the light transmittance of the epoxy resin A is 90%. The refractive index of the epoxy resin B is 1.54-1.8 and the light transmittance of the epoxy resin B is greater than 90%. The epoxy resin A is an organosilicon modified epoxy resin. The epoxy resin B is another type of epoxy resin. The organosilicon modified epoxy resin satisfying a specific condition and another type of epoxy resin also satisfying the specific condition are combined to form a specific epoxy resin composition. The composite material prepared from the epoxy resin composition, a curing agent, and a curing accelerator has the advantages of having high light transmittance and high bending strength, and also has high bonding strength.

### CROSS-REFERENCE TO RELATED APPLICATION

This application claims priority of China Patent Application No. 202011577184X, filed on Dec. 28, 2020, entitled “EPOXY RESIN COMPOSITION AND TRANSPARENT COMPOSITE MATERIAL COMPRISING SAME, AND LAMINATED BOARD”, the content of which is hereby incorporated by reference in its entirety.

### TECHNICAL FIELD

The present disclosure relates to the technical field of composite materials, in particular to an epoxy resin composition and a transparent composite material comprising the same and a laminated board.

### BACKGROUND

With the rapid development of the electronics industry, an increasingly urgent need exists for highly transparent composite materials. For example, a conventional transparent composite material is as follows: a transparent resin composition, having an Abbe number of not less than 45 and including a transparent resin (a) and a glass filler (b). Further, the difference in refractive index between the transparent resin (a) and the glass filler (b) in the transparent resin composition is not more than 0.01. The transparent resin (a) in the transparent resin composition is composed of at least one substance having a higher refractive index than that of the glass filler (b) and at least one substance having a lower refractive index than that of the glass filler (b). The glass filler (b) in the transparent resin composition has a refractive index of 1.45 to 1.55. The transparent resin (a) in the transparent resin composition is a cross-linked acrylate resin having at least bifunctional (methyl) acrylate as the main component. The cross-linked acrylate resin contains (methyl) acrylate having an alicyclic structure as its constituent.

Although the conventional transparent composite material as mentioned above has improved light transmittance, its flexural strength is unsatisfactory.

### SUMMARY

Accordingly, the main purpose of the present disclosure is to provide an epoxy resin composition and a transparent composite material comprising the same, and a laminated board. The composite material prepared from the epoxy resin composition provided in the present disclosure, a curing agent, and a curing accelerator as raw materials not only has high light transmittance, but also has high flexural strength.

Particular technical solutions include the follows.

An epoxy resin composition is provided, comprising an epoxy resin A and an epoxy resin B.

A refractive index of the epoxy resin A is 1.54 to 1.8 and a light transmittance of the epoxy resin A is greater than 90%.

A refractive index of the epoxy resin B is 1.54 to 1.8 and a light transmittance of the epoxy resin B is greater than 90%.

The epoxy resin A is an organosilicon modified epoxy resin and the epoxy resin B is another type of epoxy resin.

In an embodiment, the organosilicon modified epoxy resin is at least one selected from a group consisting of hydroxyl-terminated polydimethylsiloxane modified epoxy resin, polymethylphenylsiloxane modified epoxy resin, amino-terminated polydimethylsiloxane modified epoxy resin, and aminopropyl-terminated polydimethyldiphenylsiloxane modified epoxy resin.

In an embodiment, the another type of epoxy resin is selected from a group consisting of bisphenol A epoxy resin, bisphenol F epoxy resin, glycidyl ester epoxy resin, and polyphenolic glycidyl ether epoxy resin.

In an embodiment, amass ratio of the epoxy resin A to the epoxy resin B is (1 to 3):1.

In an embodiment, the mass ratio of the epoxy resin A to the epoxy resin B is (1.25 to 2):1.

An epoxy resin composite material is provided, comprising the epoxy resin composition as described above, a curing agent, and a curing accelerator.

In an embodiment, the curing agent is at least one selected from a group consisting of ethylenediamine, modified hexamethylenediamine, hexamethylenediamine adduct, dicyandiamide, diaminodiphenyl methane, and diaminodiphenyl sulfone.

In an embodiment, the curing accelerator is at least one selected from a group consisting of N,N-dimethylbenzylamine, triethylamine, N,N-dimethylaniline, imidazoles accelerator, and peroxides accelerator.

In an embodiment, the epoxy resin composite material further comprises an additional functional additive. The additional functional additive is at least one selected from a group consisting of an antioxidant, an anti-ultraviolet additive, a dispersant, and a diluent.

A method for preparing the epoxy resin composite material as described above, comprising:
providing the epoxy resin composition, the curing agent, the curing accelerator, and a solvent, and mixing them.

In an embodiment, the solvent is dimethylformamide and/or propylene glycol methyl ether.

A prepreg is provided, which is made from a raw material comprising a glass filler and a resin material. The resin material is made from a raw material comprising the epoxy resin composition as described above or the epoxy resin composite material as described above.

A method for preparing the prepreg as described above is provided, comprising: impregnating the glass filler into the resin material, and heating.

In an embodiment, a temperature for the heating is 150° C. to 180° C. and a time for the heating is 2 minutes to 5 minutes.

A laminated board is provided, comprising a laminate of a prepreg which is made from a raw material comprising the epoxy resin composition as described above or the epoxy resin composite material as described above, or which is the prepreg as described above.

In an embodiment, the laminate is further coated with a release film on one or both sides thereof.

A method for preparing the laminated board as described above is provided, comprising: providing the prepreg, and laminating the prepreg followed by hot pressing under vacuum.

In an embodiment, conditions for the hot pressing under vacuum comprise a temperature of 150° C. to 180° C., a pressure of 10 kgf/cm² to 20 kgf/cm², and a hot pressing time of 60 minutes to 90 minutes.

In an embodiment, the preparing method further comprises: coating a release film on one or both sides of a laminate obtained in the laminating.

Compared to the relevant art, the present disclosure has the following beneficial effects.

In the present disclosure, the organosilicon modified epoxy resin satisfying a specific condition (i.e., 1.54 to 1.8 and a light transmittance greater than 90%) and another type of epoxy resin also satisfying this specific condition are combined to form a specific epoxy resin composition. A composite material prepared from the epoxy resin composition, a curing agent, and a curing accelerator has advantages of high light transmittance and high flexure strength, and also has high bonding strength.

### BRIEF DESCRIPTION OF THE DRAWINGS

FIG. 1 is a schematic structural view of a laminated board according to an embodiment of the present disclosure.

### DETAILED DESCRIPTION OF THE EMBODIMENTS

In order to facilitate the understanding of the present disclosure, the below will make a complete description of the present disclosure. However, the present disclosure can be implemented in many different forms and is not limited to the embodiments described herein. On the contrary, these embodiments are provided to make the understanding of the disclosure content of the present disclosure more thorough and comprehensive.

Unless otherwise defined, all technical and scientific terms used herein have the same meaning as commonly understood by one of ordinary skill in the art of the present disclosure. The terms used in the description of the present disclosure are merely for the purpose of describing specific embodiments, and are not intended to limit the present disclosure. As used herein, the term “and/or” includes any and all combinations of one or more of the associated listed items.

An epoxy resin composition is provided in embodiments of the present disclosure. The epoxy resin composition includes an epoxy resin A and an epoxy resin B.

A refractive index of the epoxy resin A is 1.54 to 1.8, and a light transmittance of the epoxy resin A is greater than 90%.

A refractive index of the epoxy resin B is 1.54 to 1.8, and a light transmittance of the epoxy resin B is greater than 90%.

The epoxy resin A is an organosilicon modified epoxy resin, and the epoxy resin B is another type of epoxy resin.

In an example, the refractive index of the epoxy resin A is 1.65, and the light transmittance of the epoxy resin A is 90%. The refractive index of the epoxy resin B is 1.54, and the light transmittance of the epoxy resin B is 90%.

In an example, the organosilicon modified epoxy resin is at least one selected from a group consisting of hydroxyl-terminated polydimethylsiloxane modified epoxy resin (a refractive index of 1.65 and a light transmittance of 90%), polymethylphenylsiloxane modified epoxy resin (a refractive index of 1.65 and a light transmittance of 90%), amino-terminated polydimethylsiloxane modified epoxy resin (a refractive index of 1.65 and a light transmittance of 90%), and aminopropyl-terminated polydimethyldiphenylsiloxane modified epoxy resin (a refractive index of 1.65 and a light transmittance of 90%).

In an example, the another type of epoxy resin is selected from a group consisting of bisphenol A epoxy resin (a refractive index of 1.54 and a light transmittance of 90%), bisphenol F epoxy resin (a refractive index of 1.54 and a light transmittance of 90%), glycidyl ester epoxy resin (a refractive index of 1.54 and alight transmittance of 90%), and polyphenolic glycidyl ether epoxy resin (a refractive index of 1.54 and a light transmittance of 90%).

In an example, a mass ratio of the epoxy resin A to the epoxy resin B is (1 to 3):1.

In an example, the mass ratio of the epoxy resin A to the epoxy resin B is (1.25 to 2):1.

An epoxy resin composite material is provided in embodiments of the present disclosure. The epoxy resin composite material includes the epoxy resin composition as described above, a curing agent, and a curing accelerator.

It should be understood that, in order to achieve an ideal curing effect, appropriate amounts of the curing agent and the curing accelerator can be selected. In an example, the epoxy resin composite material provided in embodiments of the present disclosure, in parts by mass, includes:
40 to 60 parts of the Epoxy resin A,
20 to 40 parts of the Epoxy resin B,
5 to 10 parts of the curing agent, and
0.5 to 3 parts of the curing accelerator.

It should be understood that, in order to achieve an ideal curing effect, appropriate types of the curing agent and the curing accelerator can be selected.

In an example, the curing agent is at least one selected from a group consisting of ethylenediamine, modified hexamethylenediamine, hexamethylenediamine adduct, dicyandiamide, diaminodiphenyl-methane, and diaminodiphenylsulfone.

In an example, the curing accelerator is at least one selected from a group consisting of N,N-dimethylbenzylamine, triethylamine, N,N-dimethylaniline, imidazoles accelerator and peroxides accelerator.

In an example, the epoxy resin composite material further includes an additional functional additive. The additional functional additive described in the embodiments of the present disclosure includes, but not limited to, an antioxidant, an anti-ultraviolet additive, a dispersant, a diluent, or other additives. In an embodiment of the present disclosure, the antioxidant is, for example, antioxidant 1010 or other antioxidant. The anti-ultraviolet additive is, for example, ultraviolet absorber UV-O. The dispersant is, for example, dispersant 5040. The diluent is, for example, allyl glycidyl ether.

A method for preparing the epoxy resin composite material as described above is provided in embodiments of the present disclosure, which includes steps of:
providing the epoxy resin composition, the curing agent, the curing accelerator, and a solvent, and mixing them.

In an example, the solvent is dimethylformamide and/or propylene glycol methyl ether. Preferably, the solvent is dimethylformamide.

It should be understood that, the amount of the solvent in the embodiments of the present disclosure is not specifically limited. For example, 50 to 100 parts of the solvent is used in the preparation of the epoxy resin composite material having the following formulation: 40 to 60 parts of the epoxy resin A, 20 to 40 parts of the epoxy resin B, 5 to 10 parts of the curing agent, and 0.5 to 3 parts of the curing accelerator.

A prepreg is provided in embodiments of the present disclosure. The prepreg is made from a raw material including a glass filler and a resin material. The resin material is made from a raw material including the epoxy resin composition as described above or the epoxy resin composite material as described above.

The glass filler in the embodiments of the present disclosure includes, but is not limited to, glass fiber fabric such as 1080 glass fiber fabric (a basis weight of 48 g/m²).

A method for preparing the prepreg as described above is provided in embodiments of the present disclosure, which includes steps of:
impregnating the glass filler into the resin material, and heating.

In an example, a temperature for the heating is 150° C. to 180° C., and a time for the heating is 2 minutes to 5 minutes.

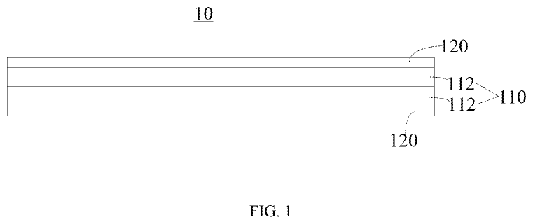

Referring to FIG. 1, a laminated board 10 is provided in embodiments of the present disclosure. The laminated board 10 includes a laminate 110 of a prepreg 112. The prepreg 112 is made from a raw material including the epoxy resin composition as described above or the epoxy resin composite material as described above. Alternatively, the prepreg is the prepreg 112 as described above.

In an example, the laminate 110 is coated with a release film 120 on one or both sides thereof.

A method for preparing the laminated board as described above is provided in embodiments of the present disclosure, which includes steps of: providing the prepreg, and laminating the prepreg followed by hot pressing under vacuum.

In an example, conditions for the hot pressing under vacuum include: a temperature of 150° C. to 180° C., a pressure of 10 kgf/cm² to 20 kgf/cm², and a hot pressing time of 60 minutes to 90 minutes.

In an example, the method further includes coating a release film on one or both sides of a laminate obtained in the laminating.

### Example 1

(1) 5 parts of dicyandiamide and 50 parts of dimethylformamide were added into a batching bottle and fully stirred to dissolve. Thereafter, 40 parts of an organosilicon modified epoxy resin, 20 parts of bisphenol A epoxy resin, 1 part of antioxidant 1010, and 0.5 parts of 2-methylimidazole were successively added into the batching bottle and fully stirred to prepare a glue solution.

(2) 1080 glass fiber fabric with a basis weight of 48 g/m² was impregnated with the glue solution, and baked in a hot air circulation oven at 180° C. for 3 minutes to obtain a prepreg having a resin content of 68%.

(3) 6 prepregs were laminated, upper and lower sides of the laminate each were coated with a release film, and then the laminate was placed in a vacuum pressing machine with programmable temperature and pressure control, and cured under vacuum at a pressure of 15 kgf/cm² and a product temperature of 180° C. for 60 minutes to obtain a laminated board with a thickness of 0.6 mm.

### Example 2

(1) 5 parts of dicyandiamide and 50 parts of dimethylformamide were added into a batching bottle and fully stirred to dissolve. Thereafter, 50 parts of hydroxyl-terminated polydimethylsiloxane modified epoxy resin, 20 parts of bisphenol A epoxy resin, 1 part of antioxidant 1010, and 0.5 parts of 2-methylimidazole were successively added into the batching bottle and fully stirred to prepare a glue solution.

(2) 1080 glass fiber fabric with a basis weight of 48 g/m² was impregnated with the glue solution, and baked in a hot air circulation oven at 180° C. for 3 minutes to obtain a prepreg having a resin content of 68%.

(3) 6 prepregs were laminated, upper and lower sides of the laminate each were coated with a release film, and then the laminate was placed in a vacuum pressing machine with programmable temperature and pressure control, and cured under vacuum at a pressure of 15 kgf/cm² and a product temperature of 180° C. for 60 minutes to obtain a laminated board with a thickness of 0.6 mm.

### Example 3

(1) 5 parts of dicyandiamide and 50 parts of dimethylformamide were added into a batching bottle and fully stirred to dissolve. Thereafter, 60 parts of hydroxyl-terminated polydimethylsiloxane modified epoxy resin, 20 parts of bisphenol A epoxy resin, 1 part of antioxidant 1010, and 0.5 parts of 2-methylimidazole were successively added into the batching bottle and fully stirred to prepare a glue solution.

(2) 1080 glass fiber fabric with a basis weight of 48 g/m² was impregnated with the glue solution, and baked in a hot air circulation oven at 180° C. for 3 minutes to obtain a prepreg having a resin content of 68%.

(3) 6 prepregs were laminated, upper and lower sides of the laminate each were coated with a release film, and then the laminate was placed in a vacuum pressing machine with programmable temperature and pressure control, and cured under vacuum at a pressure of 15 kgf/cm² and a product temperature of 180° C. for 60 minutes to obtain a laminated board with a thickness of 0.6 mm.

### Example 4

(1) 5 parts of dicyandiamide and 50 parts of dimethylformamide were added into a batching bottle and fully stirred to dissolve. Thereafter, 40 parts of hydroxyl-terminated polydimethylsiloxane modified epoxy resin, 30 parts of bisphenol A epoxy resin, 1 part of antioxidant 1010, and 0.5 parts of 2-methylimidazole were successively added into the batching bottle and fully stirred to prepare a glue solution.

(2) 1080 glass fiber fabric with a basis weight of 48 g/m² was impregnated with the glue solution, and baked in a hot air circulation oven at 180° C. for 3 minutes to obtain a prepreg having a resin content of 68%.

(3) 6 prepregs were laminated, upper and lower sides of the laminate each were coated with a release film, and then the laminate is placed in a vacuum pressing machine with programmable temperature and pressure control, and cured under vacuum at a pressure of 15 kgf/cm² and a product temperature of 180° C. for 60 minutes to obtain a laminated board with a thickness of 0.6 mm.

### Example 5

(1) 5 parts of dicyandiamide and 50 parts of dimethylformamide were added into a batching bottle and fully stirred to dissolve. Thereafter, 50 parts of hydroxyl-terminated polydimethylsiloxane modified epoxy resin, 30 parts of bisphenol A epoxy resin, 1 part of antioxidant 1010, and 0.5 parts of 2-methylimidazole were successively added into the batching bottle and fully stirred to prepare a glue solution.

(2) 1080 glass fiber fabric with a basis weight of 48 g/m² was impregnated with the glue solution, and baked in a hot air circulation oven at 180° C. for 3 minutes to obtain a prepreg having a resin content of 68%.

(3) 6 prepregs were laminated, upper and lower sides of the laminate each were coated with a release film, and then the laminate is placed in a vacuum pressing machine with programmable temperature and pressure control, and cured under vacuum at a pressure of 15 kgf/cm² and a product temperature of 180° C. for 60 minutes to obtain a laminated board with a thickness of 0.6 mm.

### Example 6

(1) 5 parts of dicyandiamide and 50 parts of dimethylformamide were added into a batching bottle and fully stirred to dissolve. Thereafter, 60 parts of hydroxyl-terminated polydimethylsiloxane modified epoxy resin, 30 parts of bisphenol A epoxy resin, 1 part of antioxidant 1010, and 0.5 parts of 2-methylimidazole were successively added into the batching bottle and fully stirred to prepare a glue solution.

(2) 1080 glass fiber fabric with a basis weight of 48 g/m² was impregnated with the glue solution, and baked in a hot air circulation oven at 180° C. for 3 minutes to obtain a prepreg having a resin content of 68%.

(3) 6 prepregs were laminated, upper and lower sides of the laminate each were coated with a release film, and then the laminate was placed in a vacuum pressing machine with programmable temperature and pressure control, and cured under vacuum at a pressure of 15 kgf/cm² and a product temperature of 180° C. for 60 minutes to obtain a laminated board with a thickness of 0.6 mm.

### Example 7

(1) 5 parts of dicyandiamide and 50 parts of dimethylformamide were added into a batching bottle and fully stirred to dissolve. Thereafter, 40 parts of hydroxyl-terminated polydimethylsiloxane modified epoxy resin, 40 parts of bisphenol A epoxy resin, 1 part of antioxidant 1010, and 0.5 parts of 2-methylimidazole were successively added into the batching bottle and fully stirred to prepare a glue solution.

(2) 1080 glass fiber fabric with a basis weight of 48 g/m² was impregnated with the glue solution, and backed in a hot air circulation oven at 180° C. for 3 minutes to obtain a prepreg having a resin content of 68%.

(3) 6 prepregs were laminated, upper and lower sides of the laminate each were coated with a release film, and then the laminate was placed in a vacuum pressing machine with programmable temperature and pressure control, and cured under vacuum at a pressure of 15 kgf/cm² and a product temperature of 180° C. for 60 minutes to obtain a laminated board with a thickness of 0.6 mm.

### Example 8

(1) 5 parts of dicyandiamide and 50 parts of dimethylformamide were added into a batching bottle and fully stirred to dissolve. Thereafter, 50 parts of hydroxyl-terminated polydimethylsiloxane modified epoxy resin, 40 parts of bisphenol A epoxy resin, 1 part of antioxidant 1010, and 0.5 parts of 2-methylimidazole were successively added into the batching bottle and fully stirred to prepare a glue solution.

(2) 1080 glass fiber fabric with a basis weight of 48 g/m² was impregnated with the glue solution, and baked in a hot air circulation oven at 180° C. for 3 minutes to obtain a prepreg having a resin content of 68%.

(3) 6 prepregs were laminated, upper and lower sides of the laminate each were coated with a release film, and the laminate is placed in a vacuum pressing machine with programmable temperature and pressure control, and cured under vacuum at a pressure of 15 kgf/cm² and a product temperature of 180° C. for 60 minutes to obtain a laminated board with a thickness of 0.6 mm.

### Example 9

(1) 5 parts of dicyandiamide and 50 parts of dimethylformamide were added into a batching bottle and fully stirred to dissolve. Thereafter, 60 parts of hydroxyl-terminated polydimethylsiloxane modified epoxy resin, 40 parts of bisphenol A epoxy resin, 1 part of antioxidant 1010, and 0.5 parts of 2-methylimidazole were successively added into the batching bottle and fully stirred to prepare a glue solution.

(2) 1080 glass fiber fabric with a basis weight of 48 g/m² was impregnated with the glue solution, and baked in a hot air circulation oven at 180° C. for 3 minutes to obtain a prepreg having a resin content of 68%.

(3) 6 prepregs were laminated, upper and lower sides of the laminate each were coated with a release film, and the laminate was placed in a vacuum pressing machine with programmable temperature and pressure control, and cured under vacuum at a pressure of 15 kgf/cm² and a product temperature of 180° C. for 60 minutes to obtain a laminated board with a thickness of 0.6 mm.

### Example 10

(1) 5 parts of dicyandiamide and 50 parts of dimethylformamide were added into a batching bottle and fully stirred to dissolve. Thereafter, 40 parts of hydroxyl-terminated polydimethylsiloxane modified epoxy resin, 25 parts of bisphenol A epoxy resin, 1 part of antioxidant 1010, and 0.5 parts of 2-methylimidazole were successively added into the batching bottle and fully stirred to prepare a glue solution.

(2) 1080 glass fiber fabric with a basis weight of 48 g/m² was impregnated with the glue solution, and baked in a hot air circulation oven at 180° C. for 3 minutes to obtain a prepreg having a resin content of 68%.

(3) 6 prepregs were laminated, upper and lower sides of the laminate each were coated with a release film, and the laminate was placed in a vacuum press with programmable temperature and pressure control, and cured under vacuum at a pressure of 15 kgf/cm² and a product temperature of 180° C. for 60 minutes to obtain a laminated board with a thickness of 0.6 mm.

### Example 11

(1) 5 parts of dicyandiamide and 50 parts of dimethylformamide were added into a batching bottle and fully stirred to dissolve. Thereafter, 50 parts of hydroxyl-terminated polydimethylsiloxane modified epoxy resin, 25 parts of bisphenol A epoxy resin, 1 part of antioxidant 1010, and 0.5 parts of 2-methylimidazole were successively added into the batching bottle and fully stirred to prepare a glue solution.

(2) 1080 glass fiber fabric with a basis weight of 48 g/m² was impregnated with the glue solution, and baked in a hot air circulation oven at 180° C. for 3 minutes to obtain a prepreg having a resin content of 68%.

(3) 6 prepregs were laminated, upper and lower sides of the laminate each were coated with a release film, and the laminate was placed in a vacuum pressing machine with programmable temperature and pressure control, and cured under vacuum at a pressure of 15 kgf/cm² and a product temperature of 180° C. for 60 minutes to obtain a laminated board with a thickness of 0.6 mm.

### Example 12

(1) 5 parts of dicyandiamide and 50 parts of dimethylformamide were added into a batching bottle and fully stirred to dissolve. Thereafter, 60 parts of hydroxyl-terminated polydimethylsiloxane modified epoxy resin, 25 parts of bisphenol A epoxy resin, 1 part of antioxidant 1010, and 0.5 parts of 2-methylimidazole were successively added into the batching bottle and fully stirred to prepare a glue solution.

(2) 1080 glass fiber fabric with a basis weight of 48 g/m² was impregnated with the glue solution, and baked in a hot air circulation oven at 180° C. for 3 minutes to obtain a prepreg having a resin content of 68%.

(3) 6 prepregs were laminated, upper and lower sides of the laminate each were coated with a release film, and the laminate was placed in a vacuum pressing machine with programmable temperature and pressure control, and cured under vacuum at a pressure of 15 kgf/cm² and a product temperature of 180° C. for 60 minutes to obtain a laminated board with a thickness of 0.6 mm.

### Example 13

(1) 5 parts of dicyandiamide and 50 parts of dimethylformamide were added into a batching bottle and fully stirred to dissolve. Thereafter, 80 parts of hydroxyl-terminated polydimethylsiloxane modified epoxy resin, 10 parts of bisphenol A epoxy resin, 1 part of antioxidant 1010, and 0.5 parts of 2-methylimidazole were successively added into the batching bottle and fully stirred to prepare a glue solution.

(2) 1080 glass fiber fabric with a basis weight of 48 g/m² was impregnated with the glue solution, and baked in a hot air circulation oven at 180° C. for 3 minutes to obtain a prepreg having a resin content of 68%.

(3) 6 prepregs were laminated, upper and lower sides of the laminate each were coated with a release film, and then the laminate was placed in a vacuum pressing machine with programmable temperature and pressure control, and cured under vacuum at a pressure of 15 kgf/cm² and a product temperature of 180° C. for 60 minutes to obtain a laminated board with a thickness of 0.6 mm.

### Example 14

(1) 5 parts of dicyandiamide and 50 parts of dimethylformamide were added into a batching bottle and fully stirred to dissolve. Thereafter, 30 parts of hydroxyl-terminated polydimethylsiloxane modified epoxy resin, 60 parts of bisphenol A epoxy resin, 1 part of antioxidant 1010, and 0.5 parts of 2-methylimidazole were successively added into the batching bottle and fully stirred to prepare a glue solution.

(2) 1080 glass fiber fabric with a basis weight of 48 g/m² was impregnated with the glue solution, and baked in a hot air circulation oven at 180° C. for 3 minutes to obtain a prepreg having a resin content of 68%.

(3) 6 prepreg were laminated, upper and lower sides of the laminate each were coated with a release film, and then the laminate is placed in a vacuum pressing machine with programmable temperature and pressure control, and cured under vacuum at a pressure of 15 kgf/cm² and a product temperature of 180° C. for 60 minutes to obtain a laminated board with a thickness of 0.6 mm.

### Comparative Example 1

(1) 5 parts of dicyandiamide and 50 parts of dimethylformamide were added into a batching bottle and fully stirred to dissolve. Thereafter, 85 parts of hydroxyl-terminated polydimethylsiloxane modified epoxy resin, 1 part of antioxidant 1010, and 0.5 parts of 2-methylimidazole were successively added into the batching bottle and fully stirred to prepare a glue solution.

(2) 1080 glass fiber fabric with a basis weight of 48 g/m² was impregnated with the glue solution, and baked in a hot air circulation oven at 180° C. for 3 minutes to obtain a prepreg having a resin content of 68%.

(3) 6 prepregs were laminated, upper and lower sides of the laminate each were coated with a release film, and then the laminate was placed in a vacuum pressing machine with programmable temperature and pressure control, and cured under vacuum at a pressure of 15 kgf/cm² and a product temperature of 180° C. for 60 minutes to obtain a laminated board with a thickness of 0.6 mm.

### Comparative Example 2

(1) 5 parts of dicyandiamide and 50 parts of dimethylformamide were added into a batching bottle and fully stirred to dissolve. Thereafter, 85 parts of bisphenol A epoxy resin, 1 part of antioxidant 1010, and 0.5 parts of 2-methylimidazole were successively added into the batching bottle and fully stirred to prepare a glue solution.

(2) 1080 glass fiber fabric with a basis weight of 48 g/m² was impregnated with the glue solution, and baked in a hot air circulation oven at 180° C. for 3 minutes to obtain a prepreg having a resin content of 68%.

(3) 6 prepregs were laminated, upper and lower sides of the laminate each were coated with a release film, and then the laminate was placed in a vacuum pressing machine with programmable temperature and pressure control, and cured under vacuum at a pressure of 15 kgf/cm² and a product temperature of 180° C. for 60 minutes to obtain a laminated board with a thickness of 0.6 mm.

### Comparative Example 3

This comparative example is a comparative example of Example 12. The difference from Example 12 is in that diphenylsilanediol modified epoxy resin having a refractive index of 1.5 and a light transmittance of 90% is used to replace hydroxyl-terminated polydimethylsiloxane modified epoxy resin in Example 12.

### Comparative Example 4

This comparative example is a comparative example of Example 12. The difference from Example 12 is in that phenolic epoxy resin having a refractive index of 1.5 and a light transmittance of 90% is used to replace the bisphenol A epoxy resin in Example 12.

### Comparative Example 5

This comparative example is a comparative example of Example 12. The difference from Example 12 is in that polycarbonate, as a non-organosilicon modified epoxy resin, having a refractive index of 1.54 to 1.8 and a light transmittance greater than 90% is used to replace the organosilicon modified epoxy resin in Example 12.

### Performance Test

The laminated boards in Examples and Comparative Examples as described above were respectively taken for performing the following tests.
1. Light transmittance was tested by a spectrophotometer.
2. Bonding strength was tested according to IPC-TM-650 2.4.8. The laminated board was cut into a sample strip having a width of 3.18 mm and a length of 50.8 mm, which was sticked to a hard backboard. A certain layer of the glass fiber fabric of the laminated board was peeled off a distance of 12.7 mm. The peeled layer was then clamped with a clamp to test the bonding force between layers by the method for testing peel strength.
3. Flexural strength was tested according to IPC-TM-650 2.4.4.

TABLE 1

| | Example 1 | Example 2 | Example 3 | Example 4 |
|---|---|---|---|---|
| organosilicon modified | 40 | 50 | 60 | 40 |
| epoxy resin: hydroxyl- | | | | |
| terminated | | | | |
| polydimethylsiloxane | | | | |
| modified | | | | |
| epoxy resin | | | | |
| bisphenol A epoxy resin | 20 | 20 | 20 | 30 |
| Dicyandiamide | 5 | 5 | 5 | 5 |
| Antioxidant 1010 | 1 | 1 | 1 | 1 |
| 2-methylimidazole | 0.5 | 0.5 | 0.5 | 0.5 |
| Substrate | 1080 | 1080 | 1080 | 1080 |
| (glass fiber fabric) | | | | |
| Transmittance (%) | 84 | 76 | 75 | 82 |
| Bonding strength/ | 5.3 | 5.3 | 5.2 | 5.4 |
| (lbf/inch) | | | | |
| Flexural strength/ | 608/583 | 618/597 | 621/609 | 611/590 |
| (N/mm²) | | | | |
| warp direction/ | | | | |
| weft direction | | | | |

TABLE 2

| | Example 5 | Example 6 | Example 7 | Example 8 |
|---|---|---|---|---|
| organosilicon modified | 50 | 60 | 40 | 50 |
| epoxy resin: hydroxyl- | | | | |
| terminated | | | | |
| polydimethylsiloxane | | | | |
| modified | | | | |
| epoxy resin | | | | |
| bisphenol A epoxy resin | 30 | 30 | 40 | 40 |
| Dicyandiamide | 5 | 5 | 5 | 5 |
| Antioxidant 1010 | 1 | 1 | 1 | 1 |
| 2-Methylimidazole | 0.5 | 0.5 | 0.5 | 0.5 |
| Substrate | 1080 | 1080 | 1080 | 1080 |
| (glass fiber fabric) | | | | |
| Transmittance (%) | 84 | 85 | 77 | 80 |
| Bonding strength/ | 5.3 | 5.3 | 5.7 | 5.4 |
| (lbf/inch) | | | | |
| Flexural strength/ | 623/605 | 631/612 | 593/575 | 603/592 |
| (N/mm²) | | | | |
| warp direction/ | | | | |
| weft direction | | | | |

TABLE 3

| | Example | Example | Example | Example | Example | Example |
|---|---|---|---|---|---|---|
| | 9 | 10 | 11 | 12 | 13 | 14 |
| hydroxyl-terminated | 60 | 40 | 50 | 60 | 80 | 30 |
| polydimethylsiloxane | | | | | | |
| modified epoxy resin | | | | | | |
| Bisphenol A epoxy resin | 40 | 25 | 25 | 25 | 10 | 60 |
| Dicyandiamide | 5 | 5 | 5 | 5 | 5 | 5 |
| Antioxidant 1010 | 1 | 1 | 1 | 1 | 1 | 1 |
| 2-Methylimidazole | 0.5 | 0.5 | 0.5 | 0.5 | 0.5 | 0.5 |
| Substrate (glass fiber fabric) | 1080 | 1080 | 1080 | 1080 | 1080 | 1080 |
| Transmittance (%) | 82 | 83 | 86 | 78 | 61 | 65 |
| Bonding strength/(lbf/inch) | 5.3 | 5.4 | 5.4 | 5.2 | 5.1 | 6.0 |
| Flexural strength/(N/mm²⁾ | 610/588 | 618/599 | 628/610 | 635/620 | 648/627 | 586/572 |
| warp direction/weft direction | | | | | | |

TABLE 4

| | Comparative | Comparative | Comparative | Comparative | Comparative |
|---|---|---|---|---|---|
| | example 1 | example 2 | example 3 | example 4 | example 5 |
| organosilicon modified epoxy | 85 | 0 | 0 | 60 | 0 |
| resin: hydroxyl-terminated | | | | | |
| polydimethylsiloxane | | | | | |
| modified epoxy resin | | | | | |
| polycarbonate | 0 | 0 | 0 | 0 | 60 |
| Diphenylsilanediol modified | 0 | 0 | 60 | 0 | 0 |
| epoxy resin | | | | | |
| Bisphenol A epoxy resin | 0 | 85 | 25 | 0 | 25 |
| Phenolic epoxy resin | 0 | 0 | 0 | 25 | 0 |
| Dicyandiamide | 5 | 5 | 5 | 5 | 5 |
| Antioxidant 1010 | 1 | 1 | 1 | 1 | 1 |
| 2-Methylimidazole | 0.5 | 0.5 | 0.5 | 0.5 | 0.5 |
| Substrate (glass fiber fabric) | 1080 | 1080 | 1080 | 1080 | 1080 |
| Transmittance (%) | 50 | 20 | 48 | 30 | 30 |
| Bonding strength/(lbf/inch) | 4.0 | 4.5 | 4.1 | 4.2 | 3.5 |
| Flexural strength/(N/mm²) | 561/538 | 454/432 | 522/514 | 532/519 | 345/325 |
| warp direction/weft | | | | | |
| direction | | | | | |

### Example 15

(1) 5 parts of ethylenediamine and 50 parts of dimethylformamide were added into a batching bottle and fully stirred to dissolve. Thereafter, 40 parts of amino-terminated poly dimethylsiloxane modified epoxy resin, 20 parts of bisphenol F epoxy resin, 1 part of anti-ultraviolet additive (specifically, ultraviolet absorber UV-O), and 0.5 parts of triethylamine were successively added into the batching bottle and fully stirred to prepare a glue solution.

(2) 1080 glass fiber fabric with a basis weight of 48 g/m² was impregnated with the glue solution, and baked in a hot air circulation oven at 150° C. for 5 minutes to obtain a prepreg having a resin content of 6800.

(3) 6 prepregs were laminated, upper and lower sides of the laminate each were coated with a release film, and the laminate was placed in a vacuum pressing machine with programmable temperature and pressure control, and cured under vacuum at a pressure of 10 kgf/cm² and a product temperature of 150° C. for 80 minutes to obtain a laminated board with a thickness of 0.6 mm.

### Example 16

(1) 5 parts of dicyandiamide and 50 parts of dimethylformamide were added into a batching bottle and fully stirred to dissolve. Thereafter, 40 parts of aminopropyl-terminated polydimethyldiphenylsiloxane modified epoxy resin, 20 parts of glycidyl ester epoxy resin, 1 part of a dispersant (specifically, dispersant 5040), and 0.5 parts of N,N-dimethylaniline were successively added into the batching bottle and fully stirred to prepare a glue solution.

(2) 1080 glass fiber fabric with a basis weight of 48 g/m² was impregnated with the glue solution, and baked in a hot air circulation oven at 180° C. for 2 minutes to obtain a prepreg having a resin content of 68%.

(3) 6 prepregs were laminated, upper and lower sides of the laminate each were coated with a release film, and the laminate was placed in a vacuum pressing machine with programmable temperature and pressure control, and cured under vacuum at a pressure of 20 kgf/cm² and a product temperature of 180° C. for 50 minutes to obtain a laminated board with a thickness of 0.6 mm.

Laminated boards obtained from Example 15 and Example 16 were tested with reference to performance test method as described above. The results are shown in the following table.

TABLE 5

| | Example 15 | Example 16 |
|---|---|---|
| Transmittance (%) | 82 | 81 |
| Bonding strength/(lbf/inch) | 5.3 | 5.2 |
| Flexural strength/(N/mm²) | 621/590 | 633/605 |
| Warp direction/weft direction | | |

The technical features of the above-mentioned embodiments can be combined arbitrarily. To make the description concise, all possible combinations of the technical features in the above-mentioned embodiments are not described. However, as long as there is no contradiction in the combination of these technical features, they should be considered as within the scope of the present specification.

The above-mentioned embodiments merely express several implementation modes of the present disclosure. The descriptions of the embodiments are relatively specific and detailed, but should not be construed as limiting the scope of the present disclosure. It should be noted that several modifications and improvements can be made by those skilled in the art without departing from the inventive concept of the present disclosure, and they all belong to the protection scope of the present disclosure. Therefore, the protection scope of the present disclosure should be based on the appended claims.

1. An epoxy resin composition, comprising an epoxy resin A and an epoxy resin B;
wherein a refractive index of the epoxy resin A is 1.54 to 1.8 and a light transmittance of the epoxy resin A is greater than 90%;
wherein a refractive index of the epoxy resin B is 1.54 to 1.8 and a light transmittance of the epoxy resin B is greater than 90%; and
wherein the epoxy resin A is an organosilicon modified epoxy resin and the epoxy resin B is another type of epoxy resin.

2. The epoxy resin composition according to claim 1, wherein the organosilicon modified epoxy resin is at least one selected from a group consisting of hydroxyl-terminated polydimethylsiloxane modified epoxy resin, polymethylphenylsiloxane modified epoxy resin, amino-terminated polydimethylsiloxane modified epoxy resin, and aminopropyl-terminated polydimethyldiphenylsiloxane modified epoxy resin.

3. The epoxy resin composition according to claim 1, wherein the another type of epoxy resin is selected from a group consisting of bisphenol A epoxy resin, bisphenol F epoxy resin, glycidyl ester epoxy resin, and polyphenolic glycidyl ether epoxy resin.

4. The epoxy resin composition according to claim 1, wherein a mass ratio of the epoxy resin A to the epoxy resin B is (1 to 3):1.

5. The epoxy resin composition according to claim 4, wherein the mass ratio of the epoxy resin A to the epoxy resin B is (1.25 to 2):1.

6. An epoxy resin composite material, comprising an epoxy resin composition, a curing agent, and a curing accelerator;
wherein the epoxy resin composition comprises an epoxy resin A and an epoxy resin B;
wherein a refractive index of the epoxy resin A is 1.54 to 1.8 and a light transmittance of the epoxy resin A is greater than 90%;
wherein a refractive index of the epoxy resin B is 1.54 to 1.8 and a light transmittance of the epoxy resin B is greater than 90%; and
wherein the epoxy resin A is an organosilicon modified epoxy resin and the epoxy resin B is another type of epoxy resin.

7. The epoxy resin composite material according to claim 6, wherein the curing agent is at least one selected from a group consisting of ethylenediamine, modified hexamethylenediamine, hexamethylenediamine adduct, dicyandiamide, diaminodiphenylmethane, and diaminodiphenylsulfone.

8. The epoxy resin composite material according to claim 6, wherein the curing accelerator is at least one selected from a group consisting of N,N-dimethylbenzylamine, triethylamine, N,N-dimethylaniline, imidazoles accelerator, and peroxides accelerator.

9. The epoxy resin composite material according to claim 6, further comprising an additional functional additive, and the additional functional additive is at least one selected from a group consisting of an antioxidant, an anti-ultraviolet additive, a dispersant, and a diluent.

10. (canceled)

11. (canceled)

12. (canceled)

13. (canceled)

14. (canceled)

15. A laminated board, comprising a laminate of a prepreg, wherein the prepreg is made from a raw material comprising a glass filler and the epoxy resin composite material of claim 6.

16. The laminated board according to claim 15, wherein the laminate is coated with a release film on one or both sides thereof.

17. A method for preparing a laminated board, comprising:
mixing the epoxy resin composite material of claim 6 and a solvent to form a glue solution;
impregnating a glass filler into the glue solution and heating to provide a prepreg; and
laminating the prepreg to form a laminate, and hot pressing the laminate under vacuum.

18. The method according to claim 17, wherein conditions for the hot pressing comprise a temperature of 150° C. to 180° C., a pressure of 10 kgf/cm² to 20 kgf/cm², and a hot pressing time of 60 minutes to 90 minutes.

19. The method according to claim 17, further comprising coating a release film onto one or both sides of the laminate obtained in the laminating.

20. The epoxy resin composite material according to claim 6, wherein the organosilicon modified epoxy resin is at least one selected from a group consisting of hydroxyl-terminated polydimethylsiloxane modified epoxy resin, polymethylphenylsiloxane modified epoxy resin, amino-terminated polydimethylsiloxane modified epoxy resin, and aminopropyl-terminated polydimethyldiphenylsiloxane modified epoxy resin.

21. The epoxy resin composite material according to claim 6, wherein the another type of epoxy resin is selected from a group consisting of bisphenol A epoxy resin, bisphenol F epoxy resin, glycidyl ester epoxy resin, and polyphenolic glycidyl ether epoxy resin.

22. The epoxy resin composite material according to claim 6, wherein a mass ratio of the epoxy resin A to the epoxy resin B is (1 to 3):1.

23. The epoxy resin composite material according to claim 6, further comprising a solvent.

24. The epoxy resin composite material according to claim 14, wherein the solvent is dimethylformamide and/or propylene glycol methyl ether.

25. The laminated board according to claim 15, wherein the glass filler is a glass fiber fabric.
